(19) United States
(12) Patent Application Publication
(10) Pub. No.: US 2025/0297837 A1
(43) Pub. Date: Sep. 25, 2025

(54) LAUNCH-INITIATED EYELID WINDOW PROTECTION COVER

(71) Applicant: BAE Systems Information and Electronic Systems Integration Inc., Nashua, NH (US)

(72) Inventors: Jacob W. Miska, Nashua, NH (US); Matthew F. Chrobak, Groton, MA (US)

(73) Assignee: BAE Systems Information and Electronic Systems Integration Inc., Nashua, NH (US)

(21) Appl. No.: 18/609,831

(22) Filed: Mar. 19, 2024

(51) Int. Cl. F42B 10/46; F42B 15/08; G01D 11/26

(52) U.S. Cl. CPC F42B 10/46; F42B 15/08; G01D 11/26

(57) ABSTRACT

A guided vehicle that includes a propulsion system, a housing that is operably engaged with the propulsion system, a guidance device defining a viewing window and being operably engaged with the housing and is disposed inside of the housing, and a cover that is rotatably engaged with the housing and is configurable between a pre-flight configuration and a flight configuration. When the cover is provided in the pre-flight configuration, the viewing window is completely shielded by the cover, and when the cover is provided in the flight configuration, the viewing window is free from being shielded by the cover. When the propulsion system, the housing, and the guidance device collectively rotate in a first direction in flight, the covers rotates about the housing in a second direction opposite to the first direction wherein the cover transitions from the pre-flight configuration to the flight configuration.

### TECHNICAL FIELD

The present disclosure generally relates to a cover of a projectile that is configurable between a pre-flight configuration and a flight configuration for protecting a viewing window cover of a seeker device equipped to the projectile.

### BACKGROUND ART

In military operations, modern projectiles or ballistic devices being launched from various platforms, including mobile and stationary vehicles, may be equipped with at least one guidance kit for guiding these projectiles to a desired target or point of interest. However, these platforms may be loaded with various types of projectiles or ballistic devices having various types of guidance kits and/or systems for neutralizing desired targets or point of interests. As such, these platforms may be loaded with at least one set or group of projectiles that is equipped with a first guidance kit type and at least another set or group of projectiles that is equipped with a second guidance kit that is similar to or disguisable from the first guidance kit type.

In one particular instance, a projectile may be equipped with a seeker device or similar nose-mounted imaging device. In operation, this imaging device may be configured to search and detect an aerial target at a desired viewing angle when in flight by measuring various light wavelengths emitted by an aerial targets, including, but not limited to, infrared wavelengths, visible light wavelengths, and ultraviolet wavelengths. Such measuring of these various light wavelengths is viewed through a protective viewing window or screen that is positioned at the foremost end of the projectile. By being positioned at the foremost end of the projectile, the imaging device may have a clear, unencumbered view of the far field environment relative to the projectile.

However, in current military operations, the placement of this viewing window may become detrimental to guidance operations performed by the imaging device. In one instance, the viewing window may be exposed to soot and other debris exhausted from a rocket missile of an adjacent projectile once the adjacent projectile is launched from a platform. With such exposure, the viewing window of the imaging device may become encumbered with this soot and other rocket debris thus restricting the viewing capability of the imaging device. In another instance, the viewing window is also exposed to the external environment surrounding the platform when in flight, which could result in unwanted debris or material crashing into the viewing window of the imaging device. With such exposure, the viewing window of the imaging device may become damaged and/or marred thus restricting the viewing capability of the imaging device. While platforms may be fitted with protective tubes or housing to house and protect the projectiles, such protective housing may add unnecessary weight to the platform, reduce the overall aerodynamics of the platform, and reduce the overall number of projectiles and/or payloads that may equipped to the platform.

### SUMMARY OF THE INVENTION

In one aspect, an exemplary embodiment of the present disclosure may provide a guided vehicle. The guided vehicle includes a propulsion system, a housing that is operably engaged with the propulsion system, a guidance device defining a viewing window and being operably engaged with the housing and disposed inside of the housing, and a cover that is rotatably engaged with the housing and is configurable between a pre-flight configuration and a flight configuration. When the cover is provided in the pre-flight configuration, a viewing window of the guidance device is completely shielded by the cover, and when the cover is provided in the flight configuration, the viewing window of the guidance device is free from being shielded by the cover.

This exemplary embodiment or another exemplary embodiment may further include that when the propulsion system, the housing, and the guidance device collectively rotate in a first direction in flight, the cover rotates about the housing in a second direction opposite to the first direction wherein the cover transitions from the pre-flight configuration to the flight configuration in response to this rotation or rotational action. This exemplary embodiment or another exemplary embodiment may further include that the cover comprises: a fairing rotatably engaged with the housing; a gear system operably engaged with the housing and the fairing; and at least one set of shields operably engaged with the gear system and retractable from the pre-flight configuration to the flight configuration relative to the fairing. This exemplary embodiment or another exemplary embodiment may further include that when the cover is provided in the pre-flight configuration, the at least one set of shields is positioned ahead of and completely shields the viewing window of the guidance device; and when the cover is provided in the flight configuration, the at least one set of shields is positioned behind of and completely retracted away from and thereby exposing the viewing window of the guidance device. This exemplary embodiment or another exemplary embodiment may further include that the housing comprises: a front end; a rear end opposite to the front end; a chamber defined between the front end and the rear end to house the guidance device; and a set of retaining members that extends outwardly along the housing between the front end and the rear end external to the chamber. This exemplary embodiment or another exemplary embodiment may further include that the fairing comprises: a front end that houses the viewing window of the guidance device; a rear end opposite to the front end of the fairing; a passageway defined between the front end of the fairing and the rear end of the fairing to receive and engage with at least the front end of the housing; and an internal slot defined inside of the passageway between the front end of the fairing and the rear end of the fairing; wherein the set of retaining members and the internal slot interlockingly engage with one another so that the fairing freely rotates about the housing. This exemplary embodiment or another exemplary embodiment may further include that the gear system comprises: a rack fixedly engaged with the housing; a first pinion operably engaged with the fairing and rotatably engaged with the rack; and a gear train operably engaged with the fairing and the at least one set of shields and meshed with the first pinion. This exemplary embodiment or another exemplary embodiment may further include that the gear train comprises: a first gear operably engaged with the fairing and meshed with the first pinion; and a second gear operably engaged with the fairing and the at least one set of shields and meshed with the first gear. This exemplary embodiment or another exemplary embodiment may further include that the cover further comprises: at least another set of shields operably engaged with the gear system and retractable from the pre-flight configuration to the flight configuration relative to the fairing; and wherein the gear system further comprises: a second pinion operably engaged with the fairing and rotatably engaged with the rack; and a second gear train operably engaged with the fairing and the at least another set of shields and meshed with the second pinion. This exemplary embodiment or another exemplary embodiment may further include that the second gear train comprises: a first gear operably engaged with the fairing and meshed with the second pinion; and a second gear operably engaged with the fairing and the at least another set of shields and meshed with the first gear of the second gear train. This exemplary embodiment or another exemplary embodiment may further include that the cover further comprises: a protective shroud operably engaged with the guidance device and positioned internal of the fairing; wherein the protective shroud and the fairing are spaced apart from and free from engaging with one another. This exemplary embodiment or another exemplary embodiment may further include that the cover further comprises: a circumferential slit defined between the protective shroud and the fairing; wherein the at least one set of shields is retracted through the circumferential slit from the pre-flight configuration to the flight configuration.

In another aspect, an exemplary embodiment of the present disclosure may provide a method. The method comprises steps of: providing a cover with a housing of a guided vehicle, wherein the cover is rotatably engaged with the housing and configurable between a pre-flight configuration and a flight configuration; effecting the guided vehicle to be loaded with a platform; effecting the cover to be provided in the pre-flight configuration for protecting a viewing window of a guidance device of the guided vehicle from an external environment surrounding the guided vehicle; effecting the guided vehicle to be launched from the platform by a propulsion system; effecting the housing, the propulsion system, and the guidance device to collectively rotate in a first direction; effecting the cover to rotate in a second direction opposite to the first direction; effecting the cover to transition from the pre-flight configuration to the flight configuration, wherein the cover is retracted away from the viewing window; and effecting the guidance device to view the external environment in flight.

This exemplary embodiment or another exemplary embodiment may further include that step of effecting the cover to rotate in the second direction further comprises: effecting a rack of a gear system of the cover to rotate with the housing in the first direction; effecting a fairing of the cover to rotate about the housing in the second direction relative to the housing; effecting a pinion of the gear system to rotate about the rack of the gear system with the fairing; effecting the pinion of the gear system to apply a first rotational force on a gear train of the gear system; and effecting the gear train of the gear system to retract at least one set of shields away from the viewing window of the guidance device from the pre-flight configuration to the flight configuration. This exemplary embodiment or another exemplary embodiment may further include that the step of effecting the cover to rotate in the second direction further comprises: effecting a second pinion of the gear system to rotate about the rack of the gear system with the fairing; effecting the second pinion of the gear system to apply a second rotational force on a second gear train of the gear system; and effecting the second gear train of the gear system to retract at least another set of shields away from the viewing window of the guidance device from the pre-flight configuration to the flight configuration. This exemplary embodiment or another exemplary embodiment may further include that the steps of effecting the gear train of the gear system to retract the at least one set of shields away from the viewing window and effecting the second another gear train of the gear system to retract the at least another set of shields away from the viewing window further includes that one or both of the at least one set of shields and the at least another set of shields are substantially housed inside of the fairing when transitioned to the flight configuration. This exemplary embodiment or another exemplary embodiment may further include that the step of effecting the fairing of the cover to rotate about the housing in the second direction relative to the housing further comprises: effecting a set of retaining members of the housing to connect with the fairing inside a slot defined in the fairing; and effecting the set of retaining members to guide the fairing about the housing. This exemplary embodiment or another exemplary embodiment may further include bonding a protective shroud to the guidance device; positioning a portion of the protective shroud inside of a fairing of the cover; and effecting at least one set of shields to pass through a circumferential slit defined between the protective shroud and a fairing of the cover when transitioning from the pre-flight configuration to the flight configuration.

In yet another aspect, an exemplary embodiment of the present disclosure may provide a protective cover kit for a guided vehicle. The protective cover kit includes a guidance device that has a viewing window, a housing that is configured to encase the guidance device, and a cover that is moveably engaged with the housing between a pre-flight configuration and a flight configuration. When the guidance device and the housing collectively rotate in a first direction in flight caused by the guided vehicle, the cover rotates about the housing in a second direction opposite to the first direction wherein the cover transitions from the pre-flight configuration to the flight configuration in response to this rotation or rotational action.

This exemplary embodiment or another exemplary embodiment may further include that the cover comprises: a fairing rotatably engaged with the housing; a gear system operably engaged with the housing and the fairing; and at least one set of shields operably engaged with the gear system and retractable from the pre-flight configuration to the flight configuration relative to the fairing. This exemplary embodiment or another exemplary embodiment may further include that the gear system comprises: a rack fixedly engaged with the housing; a first pinion operably engaged with the fairing and rotatably engaged with the rack; and a gear train operably engaged with the fairing and the at least one set of shields and meshed with the first pinion. This exemplary embodiment or another exemplary embodiment may further include that the gear train comprises: a first gear operably engaged with the fairing and meshed with the first pinion; and a second gear operably engaged with the fairing and the at least one set of shields and meshed with the first gear. This exemplary embodiment or another exemplary embodiment may further include that the cover further comprises: a protective shroud operably engaged with the guidance device and positioned internal of the fairing; wherein the protective shroud and the fairing are spaced apart from and free from engaging with one another.

In yet another aspect, an exemplary embodiment of the present disclosure may provide another method. The method includes steps of installing a protective kit onto a guided vehicle, the protective kit comprising: a guidance device having a viewing window; a housing configured to encase the guidance device; and a cover moveably engaged with the housing between a pre-flight configuration and a flight configuration; protecting the viewing window by at least one set of shields of the cover in the pre-flight configuration; and rotatably engaging the at least one set of shields with the housing by a gear train of the cover.

This exemplary embodiment or another exemplary embodiment may further include that the step of installing the protective kit onto the guided vehicle further comprises: threading the housing of the protective cover kit with a body of the guided vehicle. This exemplary embodiment or another exemplary embodiment may further include steps of protecting the viewing window by at least another set of shields of the cover in the pre-flight configuration; and rotatably engaging the at least another set of shields with the housing by a second gear train of the cover.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 is a front, top, first side isometric perspective view of a guided vehicle in accordance with one aspect of the present disclosure, wherein the guided vehicle is equipped with a retractable cover to protect an imaging device in a pre-flight configuration.

FIG. 2 is a partial exploded view of the guided vehicle, wherein a housing and the retractable cover are exploded away from a body of a first guidance kit of the projectile.

FIG. 3 is a front, top, first side isometric perspective view of the housing and the cover, wherein the cover is provided in the pre-flight configuration.

FIG. 4 is a sectional view taken in the direction of line 4-4 as shown in FIG. 3.

FIG. 5 is a partial exploded view of the gear system, a first set of shields, and a second set of shields of the retractable cover, wherein the fairing is removed.

FIG. 5A is an exploded view of a first inner shield of the first set of shields and a second inner shield of the second set of shields.

FIG. 5B is an exploded view of a first outer shield of the first set of shields and a second outer shield of the second set of shields.

FIG. 6 is a sectional view similar to FIG. 4, but the imaging device is removed, the viewing window of the imaging device remains shown, and a first pinion gear and a first gear train of a gear system of the cover are shown.

FIG. 6A is an enlargement of the highlighted region shown in FIG. 5.

FIG. 7 is a sectional view taken in the direction of line 6-6 as shown in FIG. 3, wherein the imaging device is removed, the viewing window of the imaging device remains shown, and a second pinion gear and a second gear train of the gear system are shown.

FIG. 7A is an enlargement of the highlighted region shown in FIG. 6.

FIG. 8A is an operational view of the guided vehicle, wherein the guided vehicle is shown spinning in a first direction causing the first and second inner shields of the first set of shields and the second set of shields of the cover to transition from the pre-flight configuration towards the flight configuration.

FIG. 8B is another operational view similar to FIG. 8A, but the first and second inner shields of the first set of shields and the second set of shields engage with and retract the first and second outer shields of the first set of shields and the second set of shields from the pre-flight configuration to the flight configuration.

FIG. 9 is another operational view similar to FIG. 9, wherein the cover is provided in the flight configuration and the viewing window of the imaging device is exposed to the external environment.

FIG. 10 is an exemplary method flowchart.

FIG. 11 is an exemplary method flowchart.

Similar numbers refer to similar parts throughout the drawings.

### DETAILED DESCRIPTION

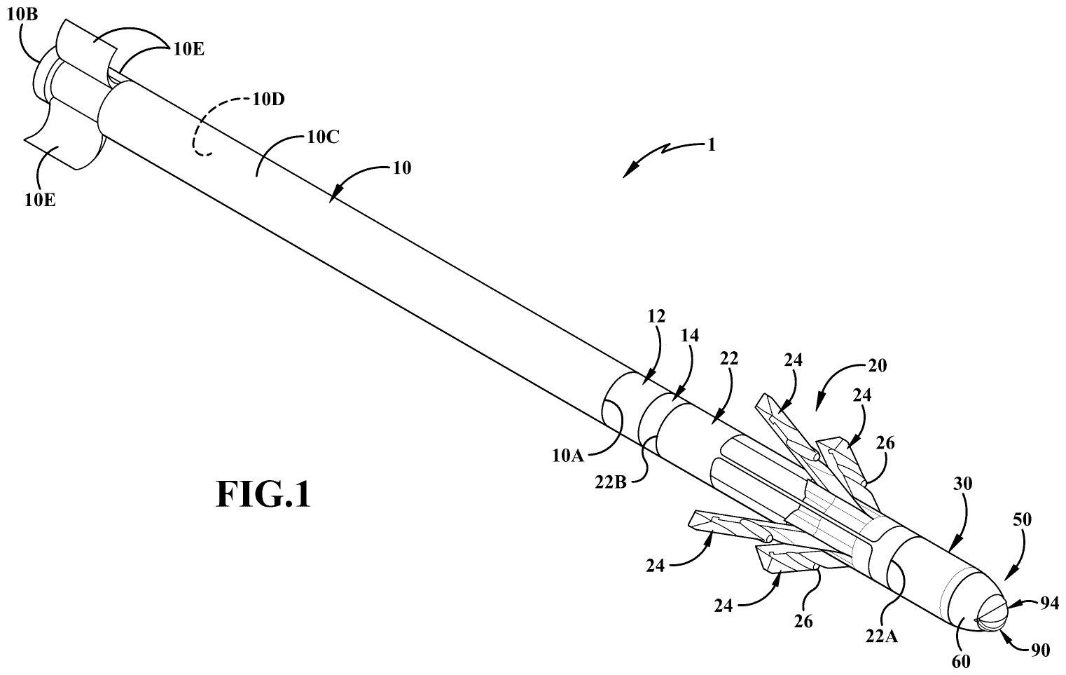

FIG. 1 illustrates a projectile, ballistic device, or guided vehicle 1 that may be equipped with a guidance kit for guiding the illustrated projectile 1 to a specific target. As provided herein, the illustrated projectile 1 is a Hydra 70 rocket equipped at least two guidance kits for guiding the illustrated projectile 1 to a specific target, which are discussed in greater detail below. It should be understood that projectile 1 may be any type of moveable device regardless of whether it is a munition. For example, the projectile 1 could also be any manned or unmanned object that needs guidance in the manner discussed herein. Such use and purpose of the at least two guidance kits with the illustrated projectile 1 are described in more detail below.

In the present disclosure, projectile 1 is configured to be launched from a ground-based or ground-vehicle platform towards a desired airborne or ground-based target. It will be understood that the platform discussed herein is exemplary only and any type of platform is contemplated to be represented. In one exemplary embodiment, the platform described herein may be represented as an aircraft or air vehicle (e.g., fixed-wing aircraft or rotary-wing aircraft that is manned or unmanned) that is capable of launching projectiles and other similar payloads from air and striking targets in air, on land, or at sea. In another exemplary embodiment, the platform described herein may be represented as hand-held launcher, a launcher fixed to a ground transporting vehicle, a launcher fixed to a naval vehicle, or other suitable launchers for launching projectiles and other similar devices from land or sea and striking targets on land or sea. In another exemplary embodiment, the platform described herein may be a ground launch vehicle that is operably engaged with a ground surface and is configured to launch surface-to-surface projectiles or missiles (or “SSM”), ground-to-ground projectiles or missiles (or “GGM”), or surface-to-air projectiles or missiles. Stated differently, the exemplary platform is capable of launching projectiles and other similar devices from land and striking targets in the air or on land or sea.

The projectile 1 may include a rocket motor or engine 10 configured to provide suitable propulsion and thrust needed for a desired military operation. The rocket motor 10 generally includes a first or front end 10A, a second or rear end 10B opposite to the first end 10A, and a longitudinal axis defined therebetween. The rocket motor 10 also generally includes a cylindrical wall 10C that extends between the first end 10A and the second end 10B along the longitudinal axis of the rocket motor 10. While not illustrated herein, suitable rocket propellants and elements may be stored inside of the cylindrical wall 10C (e.g., a chamber 10D defined inside of the cylindrical wall 10C) that generate propulsion and thrust for the rocket motor 10. The rocket motor 10 also includes an aft fin member 10E operably engaged with the cylindrical wall 10C proximate to the second end 10B of the rocket motor 10. The aft fin member 10E may provide flight assistance to the projectile 1 at the second end 10B of the rocket motor 10 as the projectile 1 travels through the air between the initial launch at the platform 2 and a desired target.

Projectile 1 also includes a warhead 12 with an impact-detonating fuse 14. As best seen in FIG. 1, the combination of the warhead 12 and impact-detonating fuse 14 threadably engage with the first end 10A of rocket motor 10. As such, the combination of the warhead 12 and impact-detonating fuse 14 are positioned ahead of and/or forward of the rocket motor 10. While the combination of the warhead 12 and impact-detonating fuse 14 are positioned ahead of and/or forward of the rocket motor 10, a combination of a warhead and an impact-detonating fuse may be positioned at any suitable position along a projectile described and illustrated herein. In one exemplary embodiment, a combination of a warhead and an impact-detonating fuse may be positioned between a seeker device described and illustrated herein and a guidance device such that the guidance device, the combination of the warhead and the impact-detonating fuse, and the seeker device may be a unitary, monolithic device that is assembled in a projectile.

Projectile 1 may also include a thermal battery or power source. If included, thermal battery may provide a desired amount of power to any electrical devices and/or assemblies included in projectile 1 that are described and illustrated herein once projectile 1 is in flight.

In the illustrated embodiment, the rocket motor 10 of the projectile 1 may be a standard 2.75-inch rocket motor (e.g., liquid-fueled rocket motors, solid-fueled rocket motors, or other suitable rocket motors of the like). In other exemplary embodiments, any suitable rocket motor may be equipped for a projectile based on the mission and/or objective.

Projectile 1 also includes a first guidance kit or apparatus (hereinafter “first guidance kit”) generally referred to as 20 that is configured to guide the projectile 1 to a specific target. The first guidance kit 20 may include legacy hardware and guidance programs that are configured to initiate and/or deploy on-board devices to guide and/or direct the projectile 1 to a specific target. The first guidance kit 20 is also configured to operably engage a rocket motor, such as rocket motor 10, to enable guidance capabilities to the rocket motor. As described above, the first guidance kit 20 provided with the projectile 1 is a legacy guidance kit and/or apparatus. In one example, the legacy guidance kit described and illustrated herein may be an Advanced Precision Kill Weapon System (APKWS) laser guidance kit manufactured by BAE Systems. In another example, the legacy guidance kit described and illustrated herein may be a preexisting or legacy guidance kit that includes commercially-available navigation equipment and/or instruments, including inertial navigation systems or inertial measurement units, for guiding and steering a projectile to a desired target.

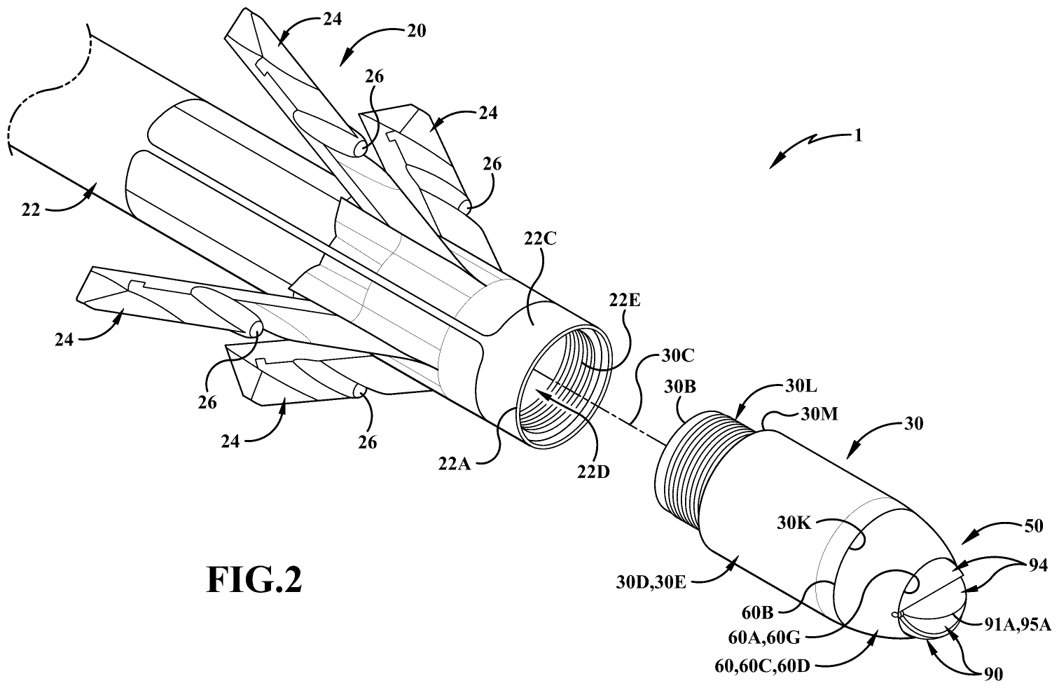

With respect to first guidance kit 20, first guidance kit 20 includes a first body 22 that operably engages with the rocket motor 10 and houses the electrical components and/or device of first guidance kit 20. As best seen in FIG. 2, body 22 includes a first end 22A, a second end 22B that is longitudinally opposite to the first end 22A and operably engages with rocket motor 10, and a wall 22C extending longitudinally between the first end 22A and the second end 22B. Still referring to FIG. 2, body 22 also defines a chamber 22D that extends from the first end 22A to the second end 22B and is accessible at the first end 22A. Still referring to FIG. 2, body 22 also includes an internal threading 22E that extends into the wall 22C at the first end 22A and is positioned inside of the chamber 22D; such use of the internal threading 22E is discussed in greater detail below.

The first guidance kit 20 may also include a set of flaperons and wings 24 that operably engages with the first body 22. As best seen in FIG. 1, each wing of the set of wings 24 is moveable on the first body 22 when the projectile 1 is launched from a platform. More particularly, the set of wings 24 is pivotable outwardly from the first body 22 and outside of the first body 22 when the projectile 1 is launched and travels through the air. In one exemplary embodiment, each wing of a set of wings discussed herein may be fixed and remain stationary with a body of a first guidance kit such that each wing of the set of wings is free from moving relative to the body of the first guidance kit.

First guidance kit 20 may also include a set of optical imaging devices or seekers 26. As best seen in FIG. 2, each optical imaging device of the set of optical imaging device 26 operably engages with a corresponding wing of the set of wings 24. In the present disclosure, a portion of each optical imaging device of the set of optical imaging devices 26 is visible to the external environment and/or far field forward of the projectile 1. During operation, each optical imaging device of the set of optical imaging devices 26 is configured to visualize and detect one or more electromagnetic wavelengths (e.g., visible light or visible spectrum wavelengths, infrared wavelengths, ultraviolet wavelengths, etc.) of desired targets, particularly aircrafts and air vehicles in flight. In one instance, each optical imaging device of the set of optical imaging devices 26 may be a laser-based guidance device and/or sensor that is led by a laser device to a desired target or point-of-interest.

Projectile 1 may include a housing 30 that operably engages the seeker device 10 with the body 6 of the projectile 1. As best seen in FIG. 2, housing 30 may include a front end 30A, a rear end 30B that operably engages with the body 22 of the first guidance kit 20 and is longitudinally opposite to the front end 30A (see FIG. 1), and a longitudinal axis 30C defined therebetween. Referring to FIG. 2, housing 30 may include a cylindrical wall 30D that extends along the longitudinal axis 30C between the front end 30A and the rear end 30B. Housing 30 may define an exterior surface 30E that extends entirely along the cylindrical wall 30D between the front end 30A and the rear end 30B and interacts with the external environment surrounding the housing 30 and projectile 1. Housing 30 may also define an interior surface 30F that extends entirely along the cylindrical wall 30D between the front end 30A and the rear end 30B.

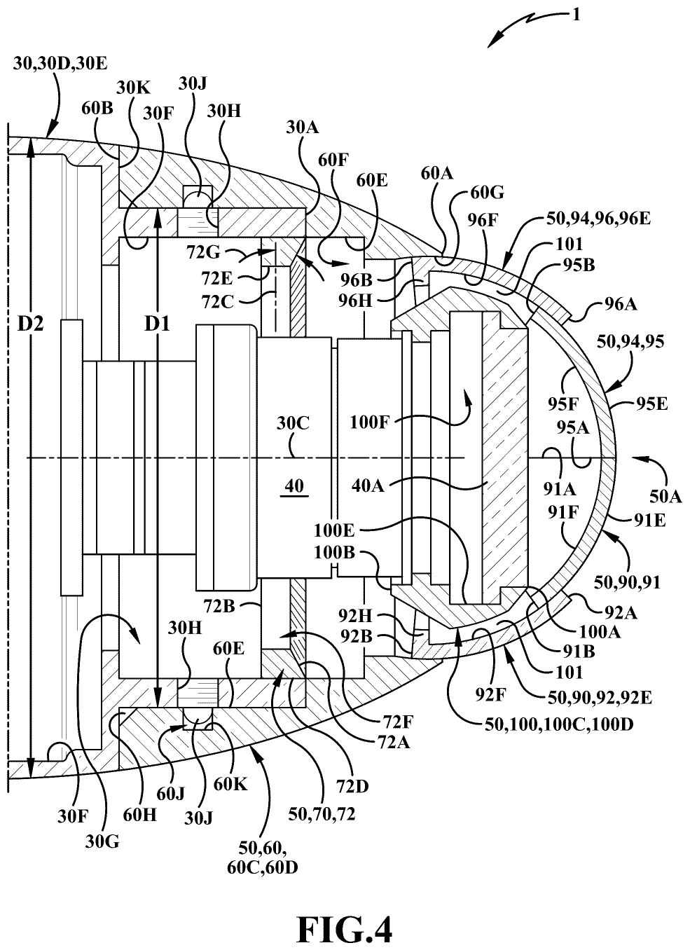

Housing 30 may also define a passageway 30G. As best seen in FIG. 4, the passageway 30G is defined by the cylindrical wall 30D and extends entirely along the cylindrical wall 30D between the front end 30A and the rear end 30B. As best seen in FIG. 4, the passageway 30G is accessible at either the front end 30A or the rear end 30B since both the front end 30A and the rear end 30B are open ends. In operation, the housing 30 is configured to house various assemblies and components of a guidance device inside of the passageway 30G for protection, which are described in greater detail below.

Housing 30 may also have at least one aperture 30H. As best seen in FIG. 4, housing 30 may define a pair of apertures 30H where each aperture of the pair of apertures 30H extends entirely through the cylindrical wall 30D from the exterior surface 30E to the interior surface 30F; the exterior surface 30E and the interior surface 30F are also in operative communication with one another at each aperture of the pair of apertures 30H. In the present disclosure, each aperture of the pair of apertures 30H is coaxial with one another along an axis that is orthogonal to the longitudinal axis 30C of the housing 30.

Housing 30 also includes at least one retaining member 30J that operably engages with the cylindrical wall 30D inside of the at least one aperture 30. As best seen in FIG. 4, housing 30 includes a pair of retaining members 30J that operably engages with the cylindrical wall 30D inside of the pair of apertures 30H. It should be noted that each retaining member of the pair of retaining members 30J may be moveable between a guided position and a seated position for attaching and guiding a fairing of a cover of the guided vehicle 1 between a pre-flight configuration and a flight configuration, which are discussed in greater detail below.

Housing 30 also includes an external shoulder 30K. As best seen in FIG. 4, the external shoulder 30K is positioned between the front end 30A and the rear end 30B of the housing 30. As discussed in greater detail below, the external shoulder 30K may be used as an external stop or barrier to prevent a fairing of a cover of the guided vehicle 1 from shifting or moving longitudinally along the housing 30.

It should be understood that the housing 30 defines at least two outer diameters with one outer diameter being measured between the front end 30A to the shoulder 30K and from the shoulder 30K to the rear end 30B. As best seen in FIG. 4, housing 30 defines a first outer diameter D1 that is measured between the front end 30A to the shoulder 30K (i.e., the retaining members 30J), and a second outer diameter D2 that is measured between the shoulder 30K to the rear end 30B where the second outer diameter D2 is greater than the first outer diameter D1. Such structural configuration of housing 30 allows for a fairing of a cover of the guided vehicle 1 to engage with the housing 30 while providing a continuous outer profile or outer surface along the aft portion of the guided projectile 1 for aerodynamic needs.

Housing 30 also defines an external threading 30L. As best seen in FIG. 2, the external threading 30L extends from the rear end 30B to an second external shoulder 30M of the housing 30 that faces that rear end 30B. In the present disclosure, the external threading 30L and the internal threading 22E of the body 22 are complementary to one another in order to threadably engage the body 22 and the housing 30 with one another.

Projectile 1 may also include a nose mounted imaging device, seeker device, or guidance device generally referred to as 40. As best seen in FIG. 4, imaging device 40 operably engages with the cylindrical wall 30D of the housing 30 and is housed inside of the housing 30. Particularly, imaging device 40 operably engages with the interior surface 30F of the cylindrical wall 30D inside of the passageway 30G. Imaging device 40 also includes a viewing window 40A that extends through the front end 30A of the housing 30 such that the viewing window 40A is the foremost component of projectile 1 in the flight configuration. In operation, the imaging device 40 is configured to search and detect an aerial target at a desired viewing angle when in flight by measuring various light wavelengths emitted by an aerial targets, including, but not limited to, infrared wavelengths, visible light wavelengths, and ultraviolet wavelengths. In the present disclosure, the imaging device 40 is configured to search and detect aircrafts and air vehicles (manned or unmanned) when in flight by measuring various light wavelengths emitted by an aerial targets.

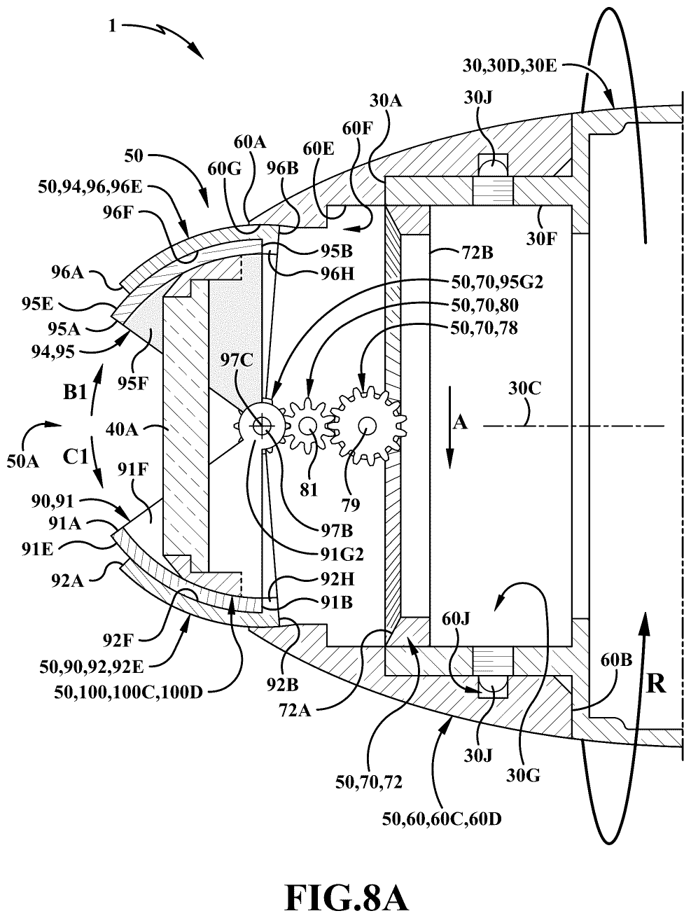

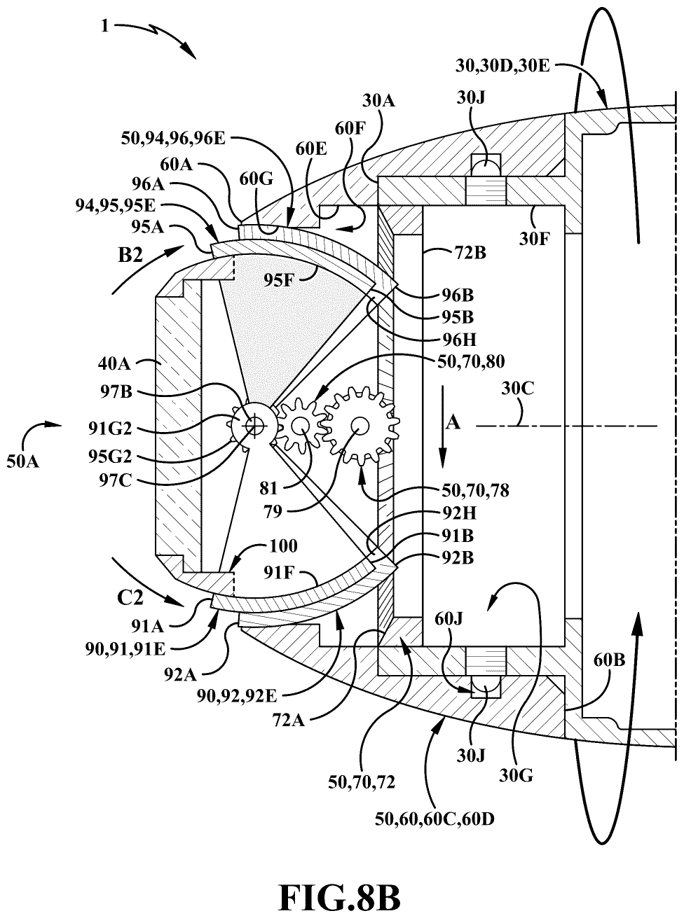

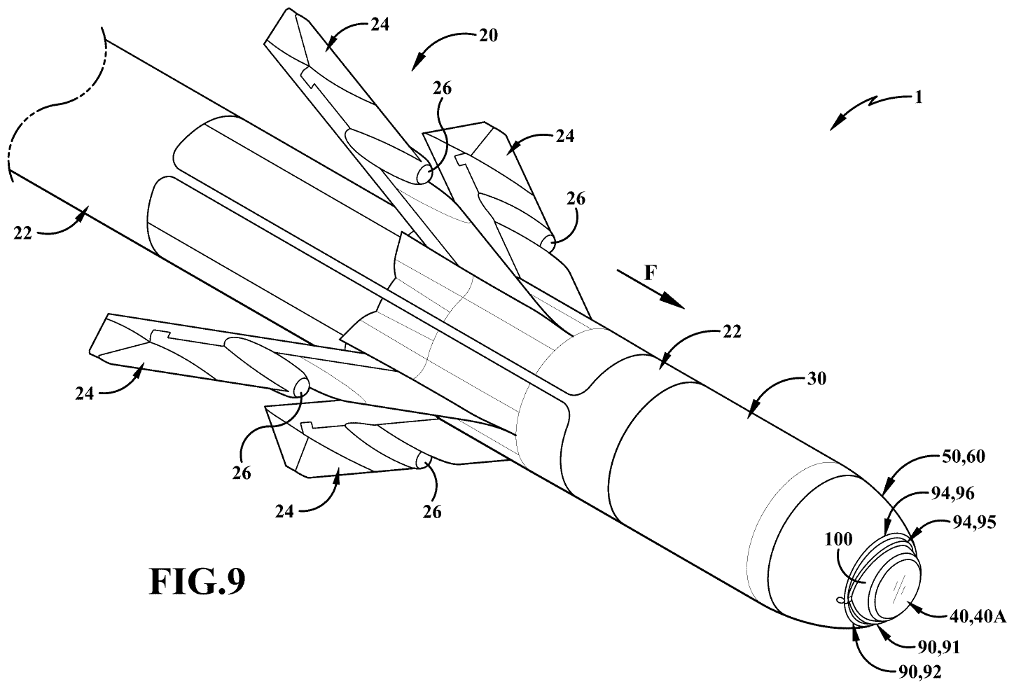

Projectile 1 may also include a retractable cover 50 that operably engages with the housing 30. In operation, retractable cover 50 is configured to be moveable along the housing 30 between a pre-flight or covered configuration (see FIGS. 1-4) and a flight or uncovered configuration (see FIGS. 8B and 9). In the covered configuration, the retractable cover 50 is configured to completely cover, protect, and/or shield the viewing window 40A of the imaging device 40 from the external environment surrounding the projectile 1 prior to being launched from a platform. In the uncovered configuration, the retractable cover 50 has retracted away into the housing 30 towards the rear end 30B and away from the viewing window 40A based on an initial spin or rotation of the projectile 1 after being launched from a platform. In the uncovered configuration, retractable cover 50 is spaced apart from the viewing window 40A so that the imaging device 40 may search and detect for an aerial target when in flight. Such components of the retractable cover 50 are discussed in greater detail below.

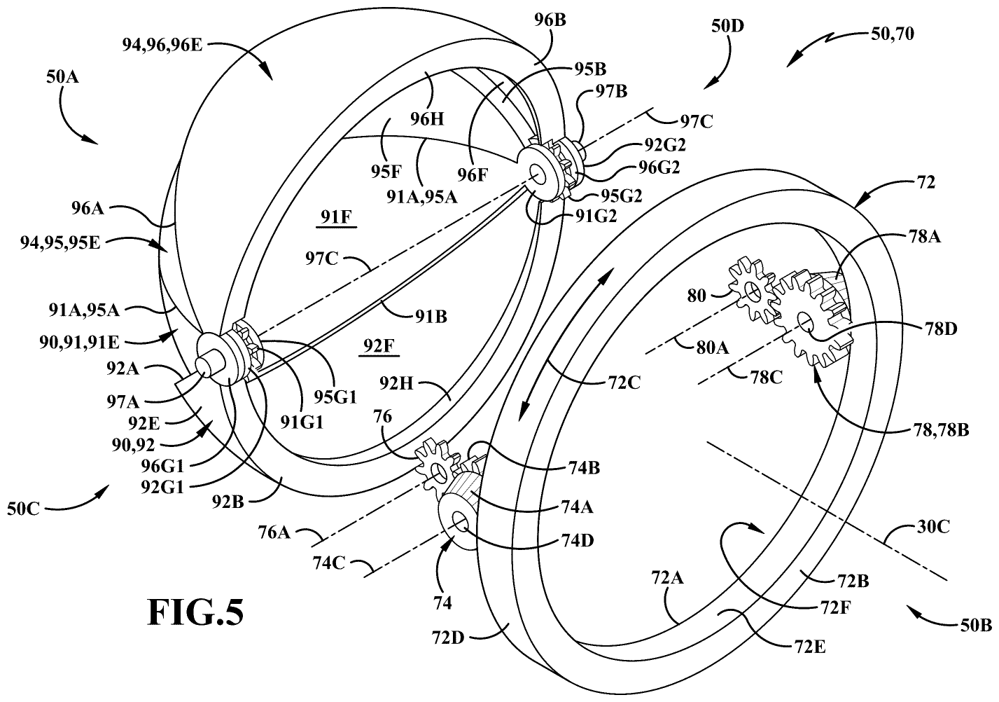

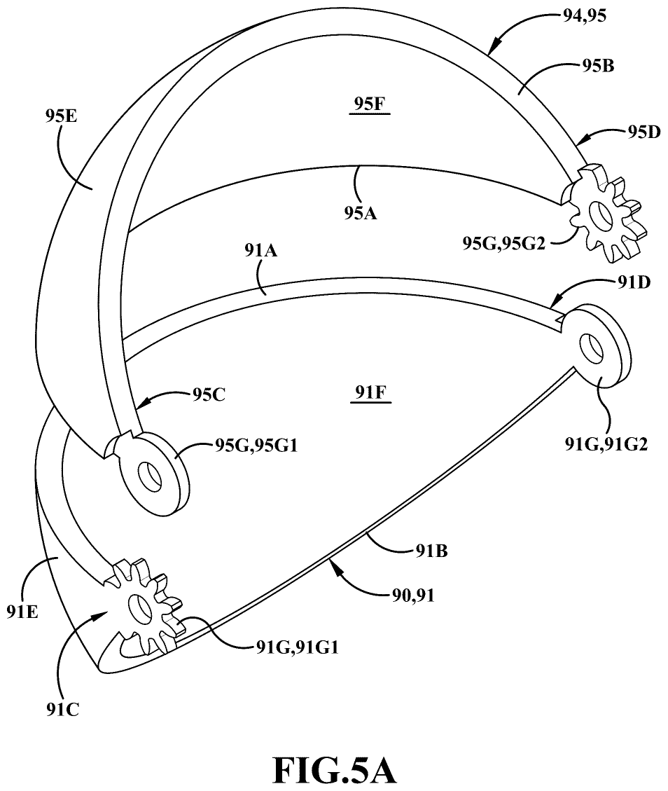

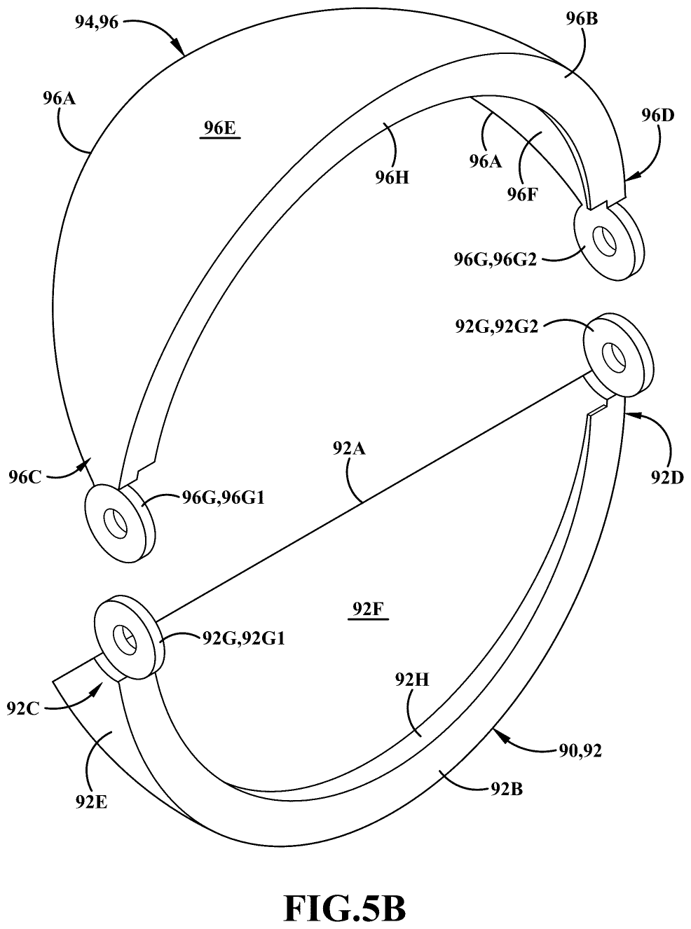

With respect to retractable cover 50, retractable cover 50 includes a first or front end 50A, a second or rear end 50B opposite to the front end 50A, an first direction defined therebetween (see FIG. 5). Retractable cover 50 also include a first side 50C, a second side 50D opposite to the first side 50C, and a second direction defined therebetween.

Retractable cover 50 includes a nose cone or fairing 60 that is rotatably engaged with the housing 30. As best seen in FIG. 4, fairing 60 includes a first or front end 60A, a second or rear end 60B longitudinally opposite to the front end 60A, and a cylindrical wall 60C that extends longitudinally between the front end 60A and the rear end 60B. Fairing 60 also includes an exterior surface 60D that extends continuously along the wall 60C between the front end 60A and the rear end 60B and faces outwardly from the fairing 60 to interact with the external environment surrounding the fairing 60. Fairing 60 also includes an interior surface 60E that extends continuously along the wall 60C between the front end 60A and the rear end 60B and faces into the fairing 60 in an opposite direction relative to the exterior surface 60D. Fairing 60 also defines a passageway 60F that extends longitudinally inside of wall 60C between the front end 60A and the rear end 60B. As best seen in FIG. 4, the passageway 60F is accessible at the front end 60A and the rear end 60B due to the front end 60A defining a front opening 60G and the rear end 60B defining a rear opening 60H.

Still referring to fairing 60, fairing 60 also defines an internal slot 60J by internal walls 60K. As best seen in FIG. 4, the internal slot 60J is defined in the circumferential wall 60C from the interior surface 60E to the internal walls 60K. The internal slot 60J is also in operative communication with the passageway 60F. In the present disclosure, the internal slot 60J also extends circumferentially about the longitudinal axis of the cylindrical wall 60C. Upon assembly of the housing 30 and the fairing 60, the retaining members 30J are received and housed inside of the passageway 30G between the front end 30A and the shoulder 30K. Upon assembly, the internal slot 60J is also configured to receive the retaining members 30J of the housing 30 such that the fairing 60 is guided by the retaining members 30J of housing 30 to freely swivel, spin, and/or rotate about the longitudinal axis 30C of the housing 30; such operations of the fairing 60 swiveling, spinning, and/or rotating about the longitudinal axis 30C of the housing 30 is discussed in greater detail below. In the present disclosure, the fairing 60 may also be pressed and locked onto the housing 30 due to the engagement capabilities of the retaining members 30J.

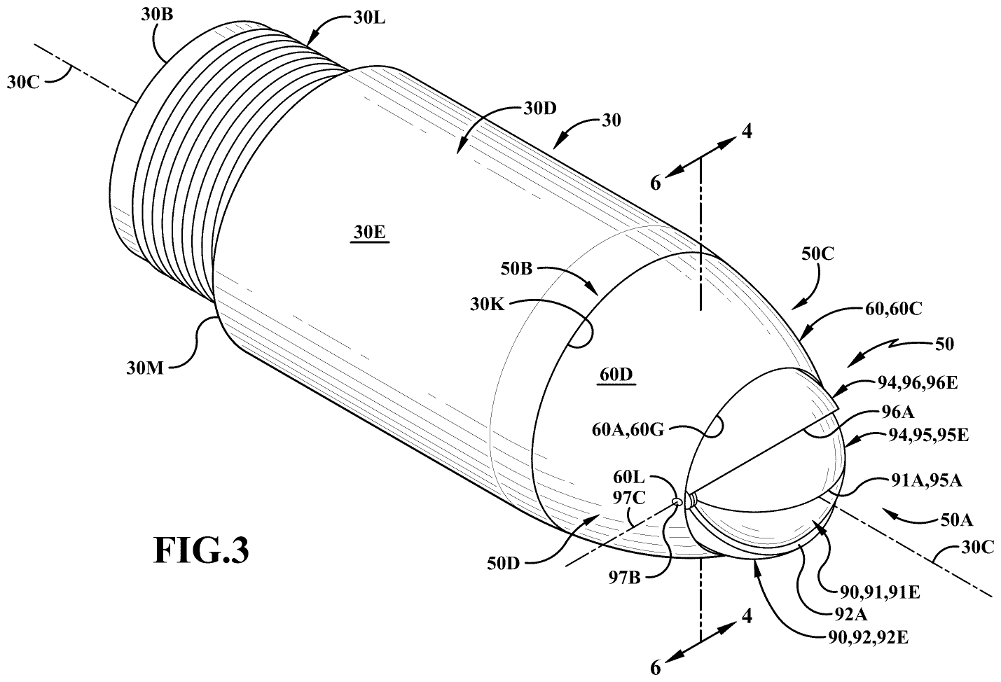

Fairing 60 also defines a set of lateral openings 60L. As best seen in FIG. 3, each lateral opening of the set of lateral openings 60L extends entirely through the cylindrical wall 60C between the exterior surface 60D and the interior surface 60E; the exterior surface 60D and the interior surface 60E are in operative communication with one another at each lateral opening of the set of lateral openings 60L. Each lateral opening of the set of lateral openings 60L is also defined at the front end 60A of the fairing 60. Such use and purpose of the set of lateral openings 60L is discussed in greater detail below.

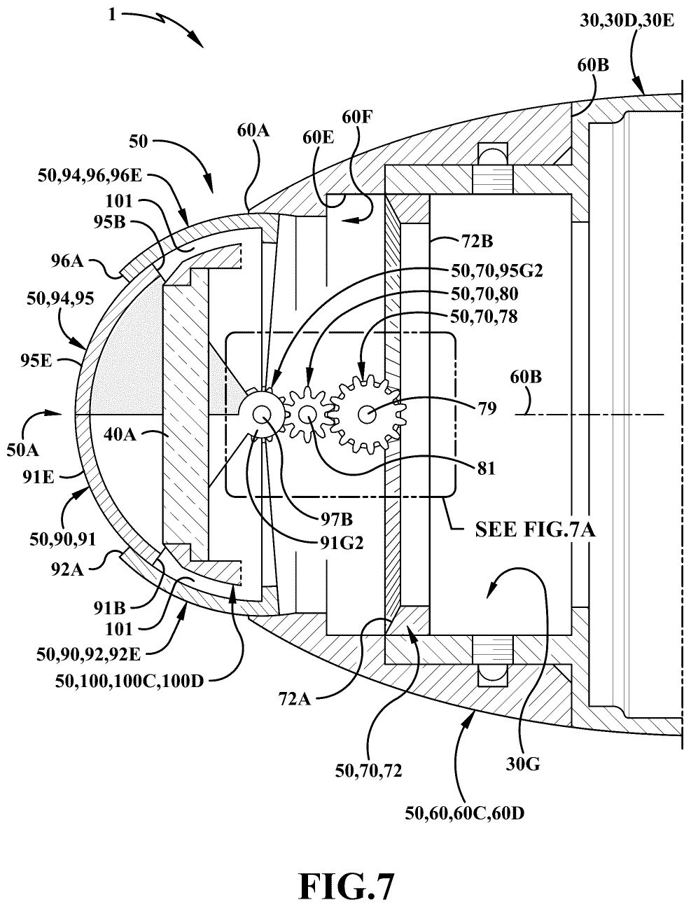

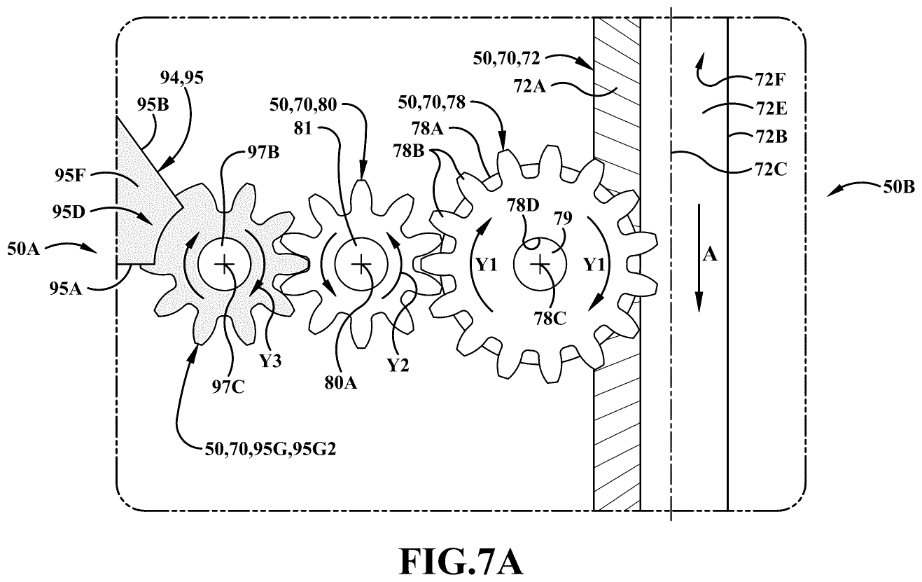

Retractable cover 50 also includes a gear system 70 that operably engages with the housing 30 and the fairing 60. As best seen in FIGS. 4 and 7, gear system 70 includes a rack 72 that operably engages with the housing 30. Referring to FIG. 7, rack 72 includes a front or engagement end 72A, a rear or non-engagement end 72B opposite to the engagement end 72A, and a circumferential path 72C that is defined between the engagement end 72A and the non-engagement end 72B and extends along the curvature of the rack 72. Rack 72 also defines an outer surface 72D that extends along the circumferential path 72C and faces outwardly away from the rack 72. Rack 72 also defines an inner surface 72E that extends along the circumferential path 72C and faces inwardly of the rack 72 opposite to the outer surface 72D. Rack 72 also defines an opening 72F that extends along the inner surface 72E between the front end 72A and the rear end 72B.

Still referring to rack 72G, the engagement end 72A is defined at an angle 72G measured relative to the circumferential path 72C. As best seen in FIG. 4, the engagement end 72A is a beveled or tapered wall that tapers inwardly from the outer surface 72D to the inner surface 72E. In the present disclosure, the angle 72G defining the engagement end 72A is an acute angle and/or an angle that is less than ninety degrees measured relative to the circumferential path 72C. In other exemplary embodiments, engagement end 72A may be defined at any suitable angle dictated by the implementation of the rack 72.

Gear system 70 also includes at least one or a first pinion 74. As best seen in FIG. 5, first pinion 74 includes a first rack engagement portion 74A, a first gear engagement portion 74B opposite to the first rack engagement portion 74A, and a rotational axis 74C extending between the first rack engagement portion 74A and the first gear engagement portion 74B. The first pinion 74 also defines a through-hole 74D that extends entirely through the first pinion 74 along the rotational axis 74C; the first rack engagement portion 74A and the first gear engagement portion 74B are also in operative communication with one another at the through-hole 74D.

The first rack engagement portion 74A may also be defined at an angle measured relative to the rotational axis 74D wherein the angle of the first rack engagement portion 74A is a congruent angle to the angle 72G of engagement end 72A of rack 72. In the present disclosure, the angle is an obtuse angle and/or an angle that is greater than ninety degrees and less than 180 degrees that is measured relative to the rotational axis 74C. With such configuration of the first rack engagement portion 74A, the rack 72 and the first pinion 74 rotatably engage with one another such that the first rack engagement portion 74A of the first pinion 74 continuously engages with the engagement end 72A of the rack 72 when the cover 60 transitions from the pre-flight configuration to the flight-configuration, which is discussed in greater detail below.

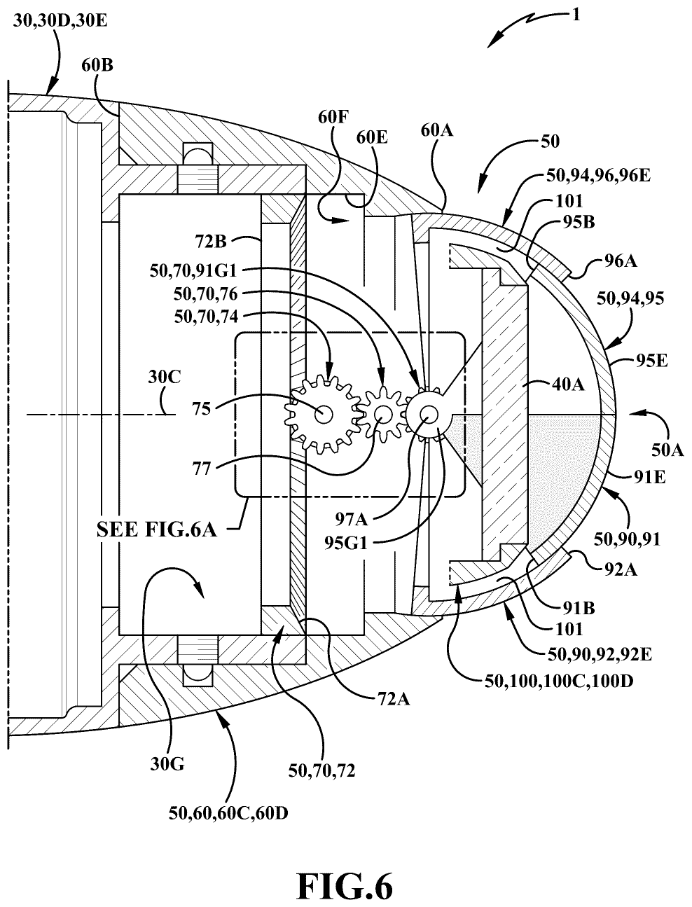

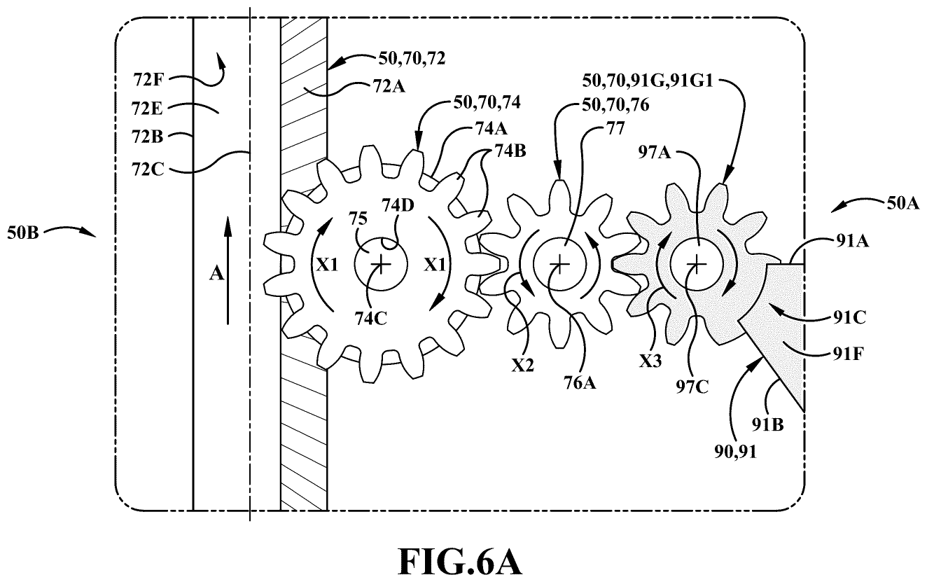

Gear system 70 also includes a first pinion pin 75. As best seen in FIG. 6A, the first pinion pin 75 passes through and is received by the through-hole 74D to operably engage the first pinion 74 with the first pinion pin 75. The first pinion pin 75 is also operably engaged with the interior surface 60E of the cylindrical wall 60° C. inside of the passageway 60F. With such engagement, the first pinion pin 75 rotatably engages the first pinion 74 with the fairing 60 such that the first pinion 74 rotates with the fairing 60 about the rotational axis 74C.

Gear system 70 also includes a first intermediate gear 76. As best seen in FIG. 6A, the first intermediate gear 76 operably engages with the first pinion 74. More particularly, the first intermediate gear 76 operably meshes with the first gear engagement portion 74B of the first pinion 74. A first intermediate gear pin 77 also operably engages with the first intermediate gear 76 and the interior surface 60E of cylindrical wall 60C inside of the passageway 60F. With such configuration, the first intermediate gear 76 rotates about a rotational axis 76A of the first intermediate gear 76 when the first pinion 74 transfers a first rotational force received from the rack 72; such rotational force is discussed in greater detail below.

Gear system 70 also includes at least another or second pinion 78. As best seen in FIG. 5, second pinion 78 includes a second rack engagement portion 78A, a second gear engagement portion 78B opposite to the first rack engagement portion 78A, and a rotational axis 78C extending between the rack engagement portion 78A and the gear engagement portion 78B. The second pinion 78 also defines a through-hole 78D that extends entirely through the second pinion 78 along the rotational axis 78C; the second rack engagement portion 78A and the second gear engagement portion 78B are also in operative communication with one another at the through-hole 78D.

The second rack engagement portion 78A is also defined at an angle measured relative to the rotational axis 78D wherein the angle of the second rack engagement portion 78A is a congruent angle to the angle 72G of engagement end 72A of rack 72. In the present disclosure, the angle is an obtuse angle and/or an angle that is greater than ninety degrees and less than 180 degrees that is measured relative to the rotational axis 78C. With such configuration of the second rack engagement portion 78A, the rack 72 and the second pinion 78 rotatably engage with one another such that the second rack engagement portion 78A of the second pinion 78 continuously engages with the engagement end 72A of the rack 72 when the cover 60 transitions from the pre-flight configuration to the flight-configuration, which is discussed in greater detail below.

Gear system 70 also includes a second pinion pin 79. As best seen in FIG. 7A, the second pinion pin 79 passes through and is received by the through-hole 78D to operably engage the second pinion 78 with the second pinion pin 79. The second pinion pin 79 is also operably engaged with the interior surface 60E of the cylindrical wall 60C inside of the passageway 60F. With such engagement, the second pinion pin 79 rotatably engages the second pinion 78 with the fairing 60 such that the second pinion 78 rotates with the fairing 60 about the rotational axis 78C.

Gear system 70 also includes a second intermediate gear 80. As best seen in FIG. 7A, the second intermediate gear 80 that is operably engaged with the second pinion 78. More particularly, the second intermediate gear 80 operably meshes with the second gear engagement portion 78B of the second pinion 78.

Gear system 70 also includes a second intermediate gear pin 81 that operably engages with the second intermediate gear 80. As best seen in FIG. 7A, second intermediate gear pin 81 operably engages with the second intermediate gear 80 and the interior surface 60E of cylindrical wall 60C inside of the passageway 60F. With such configuration, the second intermediate gear 80 rotates about a rotational axis 80A of the second intermediate gear 80 when the second pinion 78 transfers a first rotational force received from the rack 72; such rotational force is discussed in greater detail below.

Retractable cover 50 also includes a first set of shields or shutters 90. As best seen in FIG. 5, a first inner shield 91 the first set of shields 90 includes a first end 91A, a second end 91B that is opposite to the first end 91A, and a first axis defined therebetween. The first inner shield 91 of the first set of shields 90 also includes a first side 91C, a second side 91D that is opposite to the first side 91C, and a second axis defined therebetween. The first inner shield 91 of the first set of shields 90 also includes an outer surface 91E that faces outwardly away from the guided vehicle 1, and an inner surface 91F that is positioned that faces inwardly towards the guided vehicle 1 and face opposite to the outer surface 91E.

Still referring to the first inner shield 91, the first inner shield 91 also includes a pair of pivot members 91G. As best seen in FIG. 5A, a first shield gear 91G1 is formed at the first side 92C of the first inner shield 91, and a support ring 91G2 is formed at the second side 91D of the first inner shield 91. In the present disclosure, the first shield gear 91G1 and the support ring 91G2 are opposite to one another and are coaxial with one another.

It should be noted that the gear system 70 and the first set of shields 90 may operably engage with one another in any suitable configuration so that the gear system 70 may retract the first set of shields 90 away from the viewing window 40A when the guided vehicle 1 is in flight. In the present disclosure, the first shield gear 91G1 of the first inner shield 91 is part of the gear system 70 so that the first intermediate gear 76 and the first shield gear 91G1 operably mesh with one another so that the gear system 70 may retract the first set of shields 90 away from the viewing window 40A when the guided vehicle 1 is in flight. In one exemplary embodiment, the first shield gear 91G1 and the first inner shield 91 may be separate components from one another and are assembled with one another by any suitable means.

The first set of shields 90 also includes a first outer shield 92. It should be noted that the features of the first outer shield 92 are substantially similar to the features of the first inner shield 91 mentioned above. As such, a first end 92A, a second end 92B, a first side 92C, a second side 92D, an outer surface 92E, an interior surface 92F, and a second support ring 92G2 of the first outer shield 92 are substantially similar to the first end 91A, second end 91B, first side 91C, second side 91D, outer surface 91E, interior surface 91F, the support ring 91G2 of the first inner shield 91.

The first outer shield 92 of the first set of shields 90, however, may include additional and/or different components from the first inner shield 91. As best seen in FIG. 5B, a first support ring 92G1 of the first outer shield 92 is free from being formed with a gear or similar component provided with the gear system 70. As such, the first outer shield 92 is free from engaging with the gear system 70 when the retractable cover 50 is assembled with housing 30. The first outer shield 92 also includes a stop 92H. As best seen in FIG. 5B, the stop 92H is disposed on the interior surface 92F at the second end 92B. The stop 92H of the first outer shield 92 also extends between the first side 92C and the second side 92D and defines a tapered configuration therebetween. Such use and purpose of the stop 92H of the first outer shield 92 of the first set of shields 90 is discussed in greater detail below.

Retractable cover 50 also includes a second set of shields or shutters 94. As best seen in FIG. 5, a second inner shield 95 the second set of shields 94 includes a first end 95A, a second end 95B that is opposite to the first end 95A, and a first axis defined therebetween. The second inner shield 95 of the second set of shields 94 also includes a first side 95C, a second side 95D that is opposite to the first side 95C, and a second axis defined therebetween. The second inner shield 95 of the second set of shields 94 also includes an outer surface 95E that faces outwardly away from the guided vehicle 1, and an inner surface 95F that is positioned below the first end 95A, the second end 95B, the first side 95C, and the second side 95D and the opposite to the outer surface 95E.

Still referring to the second inner shield 95, the second inner shield 95 also includes a pair of pivot members 95G. As best seen in FIG. 5A, a support ring 95G1 is formed at the first side 95C of the second inner shield 95, and a second shield gear 95G2 is formed at the second side 95D of the second inner shield 95. In the present disclosure, the support ring 95G1 and the second shield gear 95G2 are opposite to one another and are coaxial with one another.

It should be noted that the gear system 70 and the second set of shields 94 may operably engage with one another in any suitable configuration so that the gear system 70 may retract the second set of shields 94 away from the viewing window 40A when the guided vehicle 1 is in flight. In the present disclosure, the second shield gear 95G2 of the second inner shield 95 is part of the gear system 70 so that the second intermediate gear 80 and the second shield gear 95G2 operably mesh with one another so that the gear system 70 may retract the second set of shields 94 away from the viewing window 40A when the guided vehicle 1 is in flight. In one exemplary embodiment, the second shield gear 95G2 and the second inner shield 95 may be separate components from one another and may e assembled with one another by any suitable means.

The second set of shields 94 also includes a second outer shield 96. It should be noted that the features of the second outer shield 96 are substantially similar to the features of the second inner shield 95 mentioned above. As such, a first end 96A, a second end 96B, a first side 96C, a second side 96D, an outer surface 96E, an interior surface 96F, and a first support ring 96G1 of the second outer shield 96 are substantially similar to the first end 95A, second end 95B, first side 95C, second side 95D, outer surface 95E, interior surface 95F, the support ring 95G1 of the second inner shield 95.

The second outer shield 96 of the second set of shields 94, however, may include additional and/or different components from the second inner shield 95. As best seen in FIG. 5B, a second support ring 96G2 of the second outer shield 96 is free from being formed with a gear or similar component provided with the gear system 70. As such, the second outer shield 96 is free from engaging with the gear system 70 when the retractable cover 50 is assembled with housing 30. The second outer shield 96 also includes a stop 96H. As best seen in FIG. 5B, the stop 96H is disposed on the interior surface 96F at the second end 96B. The stop 96H of the second outer shield 96 also extends between the first side 96C and the second side 96D and defines a tapered configuration therebetween. Such use and purpose of the stop 96H of the second outer shield 96 of the second set of shields 94 is discussed in greater detail below.

In the present disclosure, the gear system 70, the first inner shield 91, and the second inner shield 95 may create one or more gear trains for retractable cover 50. In one instance, the first intermediate gear 76 and first shield gear 91G1 of the first inner shield 91 collectively define a first gear train that operably meshes with the first pinion 74. Similarly, in another instance, the second intermediate gear 76 and second shield gear 95G2 of the second inner shield 95 collectively define a second gear train that operably meshes with the second pinion 78. In the present disclosure, the first gear train and the second gear train of the gear system 70 directly opposite one another inside of the fairing 60.

In the present disclosure, a first pivot pin 97A and a second pivot pin 97B may operably engage the fairing 60, the first set of shields 90, and the second set of shields 94 with one another. As best seen in FIG. 6, the first pivot pin 97A operably engages the fairing 60, the first sides 910, 92C of the first set of shields 90, and the first side 950, 96C of the second set of shields 94. As best seen in FIG. 5, the first pivot pin 97A also pivotably and/or operationally engages the first shield gear 91G1 of the first inner shield 91, the first support ring 92G1 of the first outer shield 92, the support ring 95G1 of the second inner shield 95, and the first support ring 96G1 of the second outer shield 96 with one another. Similarly, and as best seen in FIG. 6, the second pivot pin 97A operably engages the fairing 60, the second sides 91D, 92D of the first set of shields 90, and the second side 95D, 96D of the second set of shields 94. As best seen in FIG. 5, the second pivot pin 97B also pivotably and/or operationally engages the support ring 91G2 of the first inner shield 91, the second support ring 92G2 of the first outer shield 92, the second shield gear ring 95G2 of the second inner shield 95, and the second support ring 96G2 of the second outer shield 96 with one another. Upon such engagements, the first set of shields 90 and the second set of shields 94 rotate about a rotational axis 97C that is shared by the first pivot pin 97A and the second pivot pin 97B due to the first pivot pin 97A and the second pivot pin 97B being coaxial with one another.

It should also be understood that the first set of shields 90 and the second set of shields 94 are also arranged in a predetermined order when pivotably engaged by the first pivot pin 97A and the second pivot pin 97B. As best seen in FIG. 5, the support ring 95G1 of the second inner shield 95 directly abuts and is adjacent to the first shield gear 91G1 of the first inner shield 91, the first shield gear 91G1 of the first inner shield 91 directly abuts and is adjacent to the first support ring 92G1 of the first outer shield 92, and the first support ring 92G1 of the first outer shield 92 directly abuts and is adjacent to the first support ring 92G1 of the second outer shield 96. On the opposite end, and as best seen in FIG. 5, the support ring 91G2 of the first inner shield 91 directly abuts and is adjacent to the second shield gear 95G1 of the second inner shield 95, the second shield gear 95G1 of the second inner shield 95 directly abuts and is adjacent to the second support ring 96G2 of the second outer shield 96, and the second support ring 96G2 of the second outer shield 96 directly abuts and is adjacent to the second support ring 92G2 of the first outer shield 92.

Upon assembly, the first set of shields 90 and the second set of shields 94 are operably engaged with the gear system 70. As best seen in FIGS. 6-6A, the first intermediate gear 76 meshes with the first shield gear 91G1 in which the first shield gear 91G1 is engaged with the first inner shield 91 at the first side 91C. Such engagement enables the first shield gear 91G1 to transfer rotational force from the first intermediate gear 76 to the first inner shield 91 of the first set of shields 90 to transition the first set of shields 90 from the pre-flight configuration to the flight configuration. Similarly, and as best seen in FIGS. 6-6A, the second intermediate gear 80 meshes with the second shield gear 95G2 in which the second shield gear 95G2 is engaged with the second inner shield 95 at the second side 95D. Such engagement enables the second shield gear 95G2 to transfer rotational force from the second intermediate gear 80 to the second inner shield 95 of the second set of shields 94 to transition the second set of shields 94 from the pre-flight configuration to the flight configuration

In operation, the stop 92H of the first outer shield 92 and the stop 96H of the second outer shield 96 are useful in moving the first outer shield 92 and the second outer shield 96 from the pre-flight configuration to the flight configuration. In one instance, the second end 91B of the first inner shield 91 may contact and engage with the stop 92H of the first outer shield 92 as the first inner shield 91 is retracted into the fairing 60 from the pre-flight configuration to the flight configuration. As the first inner shield 91 is retracted into the fairing 60, the second end 91B of the first inner shield 91 presses against the stop 92H of the first outer shield 92 thus causing the first outer shield 92 to retract with the first inner shield 91 from the pre-flight configuration to the flight configuration. In this same instance, the second end 95B of the second inner shield 95 may contact and engage with the stop 96H of the second outer shield 96 as the second inner shield 95 is retracted into the fairing 60 from the pre-flight configuration to the flight configuration. As the second inner shield 95 is retracted into the fairing 60, the second end 95B of the second inner shield 95 presses against the stop 96H of the second outer shield 96 thus causing the second outer shield 96 to retract with the second inner shield 95 from the pre-flight configuration to the flight configuration.

Retractable cover 50 also includes a protective shroud 100 that operably engages with the imaging device 40. As best seen in FIG. 6, protective shroud 100 includes a first or front end 100A, a second or rear end 100B longitudinally opposite to the front end 100A, and a cylindrical wall 100C that extends longitudinally between the front end 100A and the rear end 100B. Protective shroud 100 also includes an exterior surface 100D that extends continuously along the wall 100C between the front end 100A and the rear end 100B and faces outwardly from the protective shroud 100 that interacts with the external environment surrounding the protective shroud 100. Protective shroud 100 also includes an interior surface 100E that extends continuously along the wall 100C between the front end 100A and the rear end 100B and faces into the protective shroud 100 in an opposite direction relative to the exterior surface 100D. Protective shroud 100 also defines a passageway 100F that extends longitudinally inside of wall 100C between the front end 100A and the rear end 100B. As best seen in FIG. 6, the passageway 100F is accessible at the front end 100A and the rear end 100B due to the front end 100A and the rear end 100B being open ends. Upon assembly, the fairing 60 and the protective shroud 100 are free from engaging with one another. In operation, the fairing 60 is configured to freely rotate about the protective shroud 100 when the projectile 1 performs an initial roll or spin upon being launched from a platform.

In the present disclosure, a circumferential slit or gap 101 is also defined between the fairing 60 and the protective shroud 100. As best seen in FIG. 6, the circumferential slit 101 is defined between the interior surface 60E of the fairing 60 and the exterior surface 100D of the protective shroud 100. The circumferential slit 101 also provides operative communication between the passageway 60F of the fairing 60 and the external environment surrounding the projectile 1. In operation, the circumferential slit 101 is configured to allow the first set of shields 90 and the second set of shields 94 to pass between the fairing 60 and the protective shroud 100 when the first set of shields 90 and the second set of shields 94 are retracted from the pre-flight configuration and the flight configuration.

As discussed above, the retractable cover 50 is configured to transition between a covered configuration (FIGS. 6 and 7) prior to the projectile 1 being launched from a platform and a uncovered configuration (see FIGS. 8B-9) subsequent to the retractable cover 50 experiencing an initial roll or spin generated by the projectile 1 after being launched from the platform. Such structural arrangement of the retractable cover 50 relative to the housing 30 and the imaging device 40 in both the covered configuration and the uncovered configuration is discussed in greater detail below.

In the covered configuration, the first set of shields 90 and the second set of shield 94 of the retractable cover 50 are positioned ahead of the viewing window 40A of the imaging device 40. In this configuration, the first set of shields 90 and the second set of shield 94 of the retractable cover 50 completely protect the viewing window 40A of the imaging device 40 and the protective shroud 100 from the external environment surrounding the projectile 1, including soot and other debris that may be exhausted from a rocket motor of an adjacent projectile upon being launched from a platform. In this configuration, the first end 91A of the first inner shield 91 of the first set of shields 90 and the first end 95A of the second inner shield 95 of the second set of shield 94 are engaged with one another such that external elements surrounding the projectile 1 are free from interacting with the viewing window 40A of the imaging device 40 and the protective shroud 100. In the covered configuration, the first outer shield 92 of the first set of shields 90 also overlaps with the first inner shield 91 such that a portion of the first inner shield 91 is nested inside of the first outer shield 92 to protect the viewing window 40A of the imaging device 40 from the external environment. Similarly, in the covered configuration, the second outer shield 96 of the second set of shields 94 also overlaps with the second inner shield 95 such that a portion of the second inner shield 95 is nested inside of the second outer shield 96 to protect the viewing window 40A of the imaging device 40 from the external environment.

In the uncovered configuration, the first set of shields 90 and the second set of shield 94 of the retractable cover 50 are completely removed from the viewing window 40A of the imaging device 40 so that the imaging device 40 may view the external environment forward of the projectile 1. The retractable cover 50 transitions from the covered configuration to the uncovered configuration upon receiving an initial roll or spin in a first direction as generated by the projectile 1 upon being launched from the platform.

In the uncovered configuration, the first set of shields 90 and the second set of shield 94 of the retractable cover 50 are retracted away the viewing window 40A of the imaging device 40 and the protective shroud 100 to expose the viewing window 40A to external environment surrounding the projectile 1. In this configuration, the first end 91A of the first inner shield 91 of the first set of shields 90 and the first end 95A of the second inner shield 95 of the second set of shield 94 are spaced apart from one another such that external elements surrounding the projectile 1 interacts with the viewing window 40A of the imaging device 40 and the protective shroud 100. The first outer shield 92 of the first set of shields 90 and the second outer shield 96 of the second set of shields 94 also retract away from the viewing window 40A to expose the viewing window 40A of the imaging device 40 to the external environment. In this configuration, the second end 91B of the first inner shield 91 contacts and engages with the stop 92H of the first outer shield 92 as the first inner shield 91 is retracted into the fairing 60 from the pre-flight configuration to the flight configuration. As the first inner shield 91 is retracted into the fairing 60, the second end 91B of the first inner shield 91 presses against the stop 92H of the first outer shield 92 thus causing the first outer shield 92 to retract with the first inner shield 91 from the pre-flight configuration to the flight configuration. In this same instance, the second end 95B of the second inner shield 95 contacts and engages with the stop 96H of the second outer shield 96 as the second inner shield 95 is retracted into the fairing 60 from the pre-flight configuration to the flight configuration to move the second outer shield 96.

Having now described the components of the projectile 1 having the retractable cover 50, methods of protecting the imaging device 40 prior to launch and unveiling the imaging device 40 during launch are discussed in greater detail below.

As the operator or technician is loading the projectile 1 with a platform, the retractable cover 50 is provided in the covered configuration to prevent the viewing window 40A of the imaging device 40 to be scratched or damages prior to being launched from platform. As discussed above, the retractable cover 50 is also configured to protect the viewing window 40A from any soot or debris that is generated and ejected from neighboring or adjacent projectiles being launched from the platform.

In the covered configuration, the first set of shields 90 and the second set of shield 94 of the retractable cover 50 are positioned ahead of the viewing window 40A of the imaging device 40. In this configuration, the first set of shields 90 and the second set of shield 94 of the retractable cover 50 completely protect the viewing window 40A of the imaging device 40 and the protective shroud 100 from the external environment surrounding the projectile 1, including soot and other debris that may be exhausted from a rocket motor of an adjacent projectile upon being launched from the platform. In this configuration, the first end 91A of the first inner shield 91 of the first set of shields 90 and the first end 95A of the second inner shield 95 of the second set of shield 94 are engaged with one another such that external elements surrounding the projectile 1 are free from interacting with the viewing window 40A of the imaging device 40 and the protective shroud 100. The first outer shield 92 of the first set of shields 90 and the second outer shield 96 of the second set of shields 94 also overlap with the first inner shield 91 of the first set of shields 90 and the second inner shield 95 of the second set of shield 94 to protect against the viewing window 40A of the imaging device 40 and the protective shroud 100 from the external environment.

Once the platform, either manually or automatically performed, launches the projectile 1, the projectile 1 may perform an initial roll or spin in a first direction about the longitudinal axis of the projectile 1; such initial roll or spin of the projectile 1 is denoted by an arrow labeled “R” in FIG. 8A. In one instance, the initial roll or spin performed by the projectile 1 about the longitudinal axis of the projectile 1 is about 40 Hz of angular speed. Once the initial spin occurs, initial spin creates a reactionary moment on the fairing 60 since the fairing 60 is freely rotatable about the housing 30 of projectile 1. Upon receiving this initial spin, and as best seen in FIG. 8A, the fairing 60 reacts and rotates in a second direction opposite to the first direction of the projectile 1. The engagement between the retaining members 30J of the housing 30 and the internal slot 60J of the fairing 60 enables the fairing 60 to be guided about the housing 30 when the fairing 60 begins to rotate in the second direction. Upon such rotation, components of the gear system 70, except the rack 72, rotate and/or spin with the fairing 60 relative to the housing 30 in the second direction to retract the first set of shields 90 and the second set of shields 94 away from the viewing window 40A; such actions of retracting the first set of shields 90 and the second set of shields 94 by the gear system 70 are discussed in greater detail below.

Once the projectile 1 rotates in the first direction and the fairing 60 rotates in the second opposing direction, the first pinion 74 and the second pinion 78 begin to rotate about the rack 72 with the fairing 60. As best seen in FIG. 6A, the first pinion 74 rotates about the rack 72 along the circumferential path 72C due to the rack 72 rotating with the projectile 1 in the first direction; such movement of the rack 72 in denoted by an arrow labeled “A” in FIGS. 6A, 7A, and 8A-8B. Particularly, the rack engagement portion 74A of the first pinion 74 rides along the engagement end 72A of the rack 72 as the rack 72 rotates in the first direction; the rotational of the first pinion 74 is denoted by an arrow labeled “X1” in FIG. 6A. Such rotational force of the first pinion 74 is then transferred to the first intermediate gear 76 based on the gearing of the first pinion 74 and the first intermediate gear 76, which is discussed in greater detail below. Similarly, the second pinion 78 also rotates about the rack 72 along the circumferential path 72C opposite to the first pinion 74 such that the rack engagement portion 78A of the second pinion 78 rides along the engagement end 72A of the rack 72; the rotational of the second pinion 78 is denoted by an arrow labeled “Y1” in FIG. 7A. Such rotational force of the second pinion 78 is then transferred to the second intermediate gear 80 based on the gearing of the second pinion 78 and the second intermediate gear 80, which is also discussed in greater detail below.

Initially, the first pinion 74 transfers a first rotational force to the first intermediate gear 76. As best seen in FIG. 6A, first pinion 74 transfers the first rotational force to the first intermediate gear 76 due to the gear engagement portion 74B of the first pinion 74 meshing with the first intermediate gear 76; such rotational force of first intermediate gear 76 is denoted by an arrow labeled “X2” in FIG. 6A. Based on the gearing, the first intermediate gear 76 then transfers a second rotational force to the first shield gear 91G1. As best seen in FIG. 6A, first intermediate gear 76 transfers the second rotational force to the first shield gear 91G1 due to first intermediate gear 76 and the first shield gear 91G1 meshing with one another; such rotational force of first shield gear 91G1 is denoted by an arrow labeled “X3” in FIG. 6A. The second rotational force transferred to the first shield gear 91G1 is then transferred to the first inner shield 91 of the first set of shields 90 to begin retraction of the first inner shield 91 away from the viewing window 40A; such retraction of the first inner shield 91 is denoted by an arrow labeled “B1” in FIG. 8A.

Concurrently, the second pinion 78 transfers a first rotational force to the second intermediate gear 80. As best seen in FIG. 7A, second pinion 78 transfers the first rotational force to the second intermediate gear 80 due to the gear engagement portion 78B of the second pinion 78 meshing with the second intermediate gear 80; such rotational force of second intermediate gear 80 is denoted by an arrow labeled “Y2” in FIG. 7A. Based on the gearing, the second intermediate gear 80 then transfers a second rotational force to the second shield gear 95G2. As best seen in FIG. 7A, the second intermediate gear 80 transfers the second rotational force to the second shield gear 95G2 due to second intermediate gear 80 and the second shield gear 95G2 meshing with one another; such rotational force of second shield gear 95G2 is denoted by an arrow labeled “Y3” in FIG. 7A. The second rotational force transferred to the second shield gear 95G2 is then transferred to the second inner shield 95 of the second set of shields 94 to begin retraction of the second inner shield 95 away from the viewing window 40A; such retraction of the second inner shield 95 is also denoted by an arrow labeled “C1” in FIG. 8A.

As the first intermediate gear 76 and the second intermediate gear 80 transfer rotational force to the first set of shields 90 and the second set of shields 94, the first set of shields 90 and the second set of shields 94 are retracted away from the viewing window 40A. In operation, the second rotational force transferred from the first shield gear 91G1 to the first pivot member 91G1 of the first inner shield 91 rotates the first inner shield 91 rearwardly away from the viewing window 40A and into the passageway 30G of housing 30. Similarly, and as best seen in FIG. 8A, the second rotational force transferred from the second shield gear 95G2 of the second inner shield 95 rotates the second inner shield 95 rearwardly away from the viewing window 40A and into the passageway 30G of housing 30. Upon such retraction, the first set of shields 90 and the second set of shields 94 pass through the circumferential slit 101 defined between the fairing 60 and the protective shroud 100.

As the first inner shield 91 and the second inner shield 95 independently retract from the pre-flight configuration to the flight configuration, the first inner shield 91 is configured to retract the first outer shield 92 and the second inner shield 95 is configured to retract the second outer shield 96. As best seen in FIGS. 8A-8B, the rear end 91B of the first inner shield 91 contacts and engages with the stop 92H of the first outer shield 92 as the first inner shield 91 is retracted into the fairing 60 by the gear system 70. As the second end 91B of the first inner shield 91 engages with the stop 92H of the first outer shield 92, the first inner shield 91 applies a pressing force on the first outer shield 92 at the stop 92H to move and retract the first outer shield 92 away from the viewing window 40A and into the passageway 60F of fairing 60; such movement of the first outer shield 92 by the first inner shield 91 is denoted by an arrow labeled “B2” in FIG. 8B. Similarly, the rear end 95B of the second inner shield 95 contacts and engages with the stop 96H of the second outer shield 96 as the second inner shield 95 is retracted into the fairing 60 by the gear system 70. As the second end 95B of the second inner shield 95 engages with the stop 96H of the second outer shield 96, the second inner shield 95 applies a pressing force on the second outer shield 96 at the stop 96H to move and retract the second outer shield 96 away from the viewing window 40A and into the passageway 60F of fairing 60; such movement of the second outer shield 96 by the second inner shield 95 is denoted by an arrow labeled “C2” in FIG. 8B.

Once the first set of shields 90 and the second set of shields 94 are provided in the flight configuration and retracted away from the viewing window 40A being, the imaging device 40 is free to view the far field environment forward of the projectile 1. While the air passing over the first set of shields 90 and the second set of shields 94 maintains the retractable cover 50 at the uncovered configuration, the gearing of the gear system 70 may also provide assistance in maintaining the first set of shields 90 and the second set of shields 94 at the uncovered configuration so that the imaging device 40 is free to view the far field environment forward of the projectile 1 when the projectile 1 is launched from the platform.

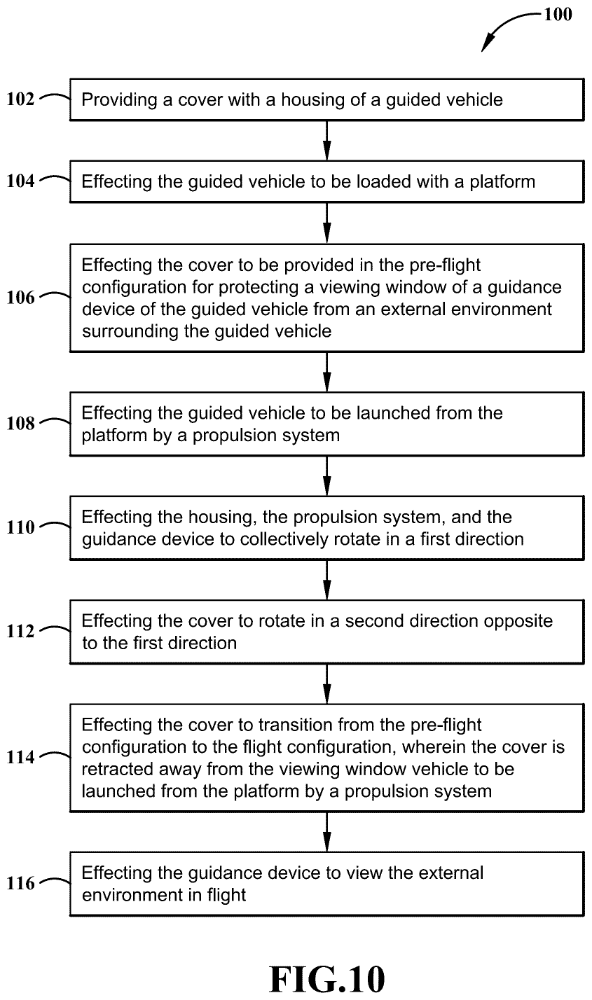

FIG. 10 includes a method 100. An initial step 102 of method 100 includes providing a cover with a housing of a guided vehicle, wherein the cover is rotatably engaged with the housing and configurable between a pre-flight configuration and a flight configuration. Another step 104 of method 100 includes effecting the guided vehicle to be loaded with a platform. Another step 106 of method 100 includes effecting the cover to be provided in the pre-flight configuration for protecting a viewing window of a guidance device of the guided vehicle from an external environment surrounding the guided vehicle. Another step 108 of method 100 includes effecting the guided vehicle to be launched from the platform by a propulsion system. Another step 110 of method 100 includes effecting the housing, the propulsion system, and the guidance device to collectively rotate in a first direction. Another step 112 of method 100 includes effecting the cover to rotate in a second direction opposite to the first direction. Another step 114 of method 100 includes effecting the cover to transition from the pre-flight configuration to the flight configuration, wherein the cover is retracted away from the viewing window. Another step 116 of method 100 includes effecting the guidance device to view the external environment in flight.

In other exemplary embodiments, method 100 may include additional and/or optional steps. In one exemplary embodiment, the step of effecting the cover to rotate in the second direction further comprises: effecting a rack of a gear system of the cover to rotate with the housing in the first direction; effecting a fairing of the cover to rotate about the housing in the second direction relative to the housing; effecting a pinion of the gear system to rotate about the rack of the gear system with the fairing; effecting the pinion of the gear system to apply a first rotational force on a gear train of the gear system; and effecting the gear train of the gear system to retract at least one set of shields away from the viewing window of the guidance device from the pre-flight configuration to the flight configuration. In another exemplary embodiment, the step of effecting the cover to rotate in the second direction further comprises: effecting a second pinion of the gear system to rotate about the rack of the gear system with the fairing; effecting the second pinion of the gear system to apply a second rotational force on a second gear train of the gear system; and effecting the second gear train of the gear system to retract at least another set of shields away from the viewing window of the guidance device from the pre-flight configuration to the flight configuration. In another exemplary embodiment, the steps of effecting the gear train of the gear system to retract the at least one set of shields away from the viewing window and effecting the second another gear train of the gear system to retract the at least another set of shields away from the viewing window further includes that one or both of the at least one set of shields and the at least another set of shields are substantially housed inside of the fairing when transitioned to the flight configuration. In another exemplary embodiment, the step of effecting the fairing of the cover to rotate about the housing in the second direction relative to the housing further comprises: effecting a set of retaining members of the housing to connect with the fairing inside a slot defined in the fairing; and effecting the set of retaining members to guide the fairing about the housing. In another exemplary embodiment, further steps include bonding a protective shroud to the guidance device; positioning a portion of the protective shroud inside of a fairing of the cover; and effecting at least one set of shields to pass through a circumferential slit defined between the protective shroud and a fairing of the cover when transitioning from the pre-flight configuration to the flight configuration.

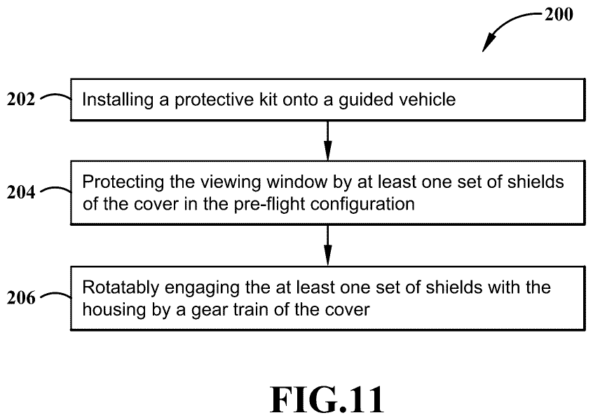

FIG. 11 includes a method 200. An initial step 202 of method 200 includes installing a protective kit onto a guided vehicle, the protective kit comprises of: a guidance device having a viewing window; a housing configured to encase the guidance device; and a cover moveably engaged with the housing between a pre-flight configuration and a flight configuration. Another step 204 of method 200 includes protecting the viewing window by at least one set of shields of the cover in the pre-flight configuration. Another step 206 of method 200 includes rotatably engaging the at least one set of shields with the housing by a gear train of the cover.

In other exemplary embodiments, method 200 may include additional and/or optional steps. In one exemplary embodiment, method 200 may further include that the step of installing the protective kit onto the guided vehicle further comprises: threading the housing of the protective cover kit with a body of the guided vehicle. In another exemplary embodiment, method 200 may further include step of protecting the viewing window by at least another set of shields of the cover in the pre-flight configuration; and rotatably engaging the at least another set of shields with the housing by a second gear train of the cover.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments. As such, one aspect or embodiment of the present disclosure may be a computer program product including least one non-transitory computer readable storage medium in operative communication with a processor, the storage medium having instructions stored thereon that, when executed by the processor, implement a method or process described herein, wherein the instructions comprise the steps to perform the method(s) or process(es) detailed herein.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of components A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/'12% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A guided vehicle, comprising:
a propulsion system;
a housing operably engaged with the propulsion system;
a guidance device defining a viewing window and being operably engaged with the housing and disposed inside of the housing; and
a cover rotatably engaged with the housing and configurable between a pre-flight configuration and a flight configuration;
wherein when the cover is in the pre-flight configuration, the viewing window of the guidance device is completely shielded by the cover, and wherein when the cover is in the flight configuration, the viewing window of the guidance device is free from being shielded by the cover.

2. The guided vehicle of claim 1, wherein when the propulsion system, the housing, and the guidance device collectively rotate in a first direction in flight, the cover rotates about the housing in a second direction opposite to the first direction wherein the cover transitions from the pre-flight configuration to the flight configuration in response to this rotation or rotational action.

3. The guided vehicle of claim 1, wherein the cover comprises:
a fairing rotatably engaged with the housing;
a gear system operably engaged with the housing and the fairing; and
at least one set of shields operably engaged with the gear system and retractable from the pre-flight configuration to the flight configuration relative to the fairing.

4. The guided vehicle of claim 3, wherein when the cover is in the pre-flight configuration, the at least one set of shields is positioned ahead of and completely shields the viewing window of the guidance device; and
wherein when the cover is in the flight configuration, the at least one set of shields is positioned behind of and completely retracted away from and thereby exposing the viewing window of the guidance device.

5. The guided vehicle of claim 3, wherein the housing comprises:
a front end;
a rear end opposite to the front end;
a chamber defined between the front end and the rear end to house the guidance device; and
a set of retaining members that extends outwardly along the housing between the front end and the rear end external to the chamber.

6. The guided vehicle of claim 5, wherein the fairing comprises:
a front end that houses the viewing window of the guidance device;
a rear end opposite to the front end of the fairing;
a passageway defined between the front end of the fairing and the rear end of the fairing to receive and engage with at least the front end of the housing; and
an internal slot defined inside of the passageway between the front end of the fairing and the rear end of the fairing;
wherein the set of retaining members and the internal slot interlockingly engage with one another so that the fairing freely rotates about the housing.

7. The guided vehicle of claim 3, wherein the gear system comprises:
a rack fixedly engaged with the housing;
a first pinion operably engaged with the fairing and rotatably engaged with the rack; and
a gear train operably engaged with the fairing and the at least one set of shields and meshed with the first pinion.

8. The guided vehicle of claim 7, wherein the gear train comprises:
a first gear operably engaged with the fairing and meshed with the first pinion; and
a second gear operably engaged with the fairing and the at least one set of shields and meshed with the first gear.

9. The guided vehicle of claim 8, wherein the cover further comprises:
at least another set of shields operably engaged with the gear system and retractable from the pre-flight configuration to the flight configuration relative to the fairing; and
wherein the gear system further comprises:
a second pinion operably engaged with the fairing and rotatably engaged with the rack; and
a second gear train operably engaged with the fairing and the at least another set of shields and meshed with the second pinion.

10. The guided vehicle of claim 9, wherein the second gear train comprises:
a first gear operably engaged with the fairing and meshed with the second pinion; and
a second gear operably engaged with the fairing and the at least another set of shields and meshed with the first gear of the second gear train.

11. The guided vehicle of claim 3, wherein the cover further comprises:
a protective shroud operably engaged with the guidance device and positioned internal of the fairing;
wherein the protective shroud and the fairing are spaced apart from and free from engaging with one another.

12. The guided vehicle of claim 11, wherein the cover further comprises:
a circumferential slit defined between the protective shroud and the fairing;
wherein the at least one set of shields is retracted through the circumferential slit from the pre-flight configuration to the flight configuration.

13. A protective cover kit for a guided vehicle, comprising:
a guidance device having a viewing window;
a housing configured to encase the guidance device; and
a cover moveably engaged with the housing between a pre-flight configuration and a flight configuration;
wherein when the guidance device and the housing collectively rotate in a first direction in flight caused by the guided vehicle, the cover rotates about the housing in a second direction opposite to the first direction wherein the cover transitions from the pre-flight configuration to the flight configuration in response to this rotation or rotational action.

14. The protective cover kit of claim 13, wherein the cover comprises:
a fairing rotatably engaged with the housing;
a gear system operably engaged with the housing and the fairing; and
at least one set of shields operably engaged with the gear system and retractable from the pre-flight configuration to the flight configuration relative to the fairing.

15. The protective cover kit of claim 14, wherein the gear system comprises:
a rack fixedly engaged with the housing;
a first pinion operably engaged with the fairing and rotatably engaged with the rack; and
a gear train operably engaged with the fairing and the at least one set of shields and meshed with the first pinion.

16. The protective cover kit of claim 15, wherein the gear train comprises:
a first gear operably engaged with the fairing and meshed with the first pinion; and
a second gear operably engaged with the fairing and the at least one set of shields and meshed with the first gear.

17. The protective cover kit of claim 13, wherein the cover further comprises:
a protective shroud operably engaged with the guidance device and positioned internal of the fairing;
wherein the protective shroud and the fairing are spaced apart from and free from engaging with one another.

18. A method comprising steps of:
installing a protective kit onto a guided vehicle, the protective kit comprising:
a guidance device having a viewing window;
a housing configured to encase the guidance device; and
a cover moveably engaged with the housing between a pre-flight configuration and a flight configuration;
protecting the viewing window by at least one set of shields of the cover in the pre-flight configuration; and
rotatably engaging the at least one set of shields with the housing by a gear train of the cover.

19. The method of claim 18, wherein the step of installing the protective kit onto the guided vehicle further comprises:
threading the housing of the protective cover kit with a body of the guided vehicle.

20. The method of claim 18, further comprising:
protecting the viewing window by at least another set of shields of the cover in the pre-flight configuration; and
rotatably engaging the at least another set of shields with the housing by a second gear train of the cover.
